(19) United States
(12) Patent Application Publication
(10) Pub. No.: US 2025/0231382 A1
(43) Pub. Date: Jul. 17, 2025

(54) OPTICAL SYSTEM AND IMAGE PICKUP APPARATUS

(71) Applicant: CANON KABUSHIKI KAISHA, Tokyo (JP)

(72) Inventors: Yuki MATSUBA, Tochigi (JP); Kenji SHINOHARA, Tochigi (JP)

(21) Appl. No.: 18/948,687

(22) Filed: Nov. 15, 2024

(30) Foreign Application Priority Data
Jan. 12, 2024 (JP) 2024-003272

(51) Int. Cl. G02B 13/18; G02B 15/14; G02B 15/22

(52) U.S. Cl. CPC G02B 13/18; G02B 15/1441; G02B 15/22

(57) ABSTRACT

An optical system includes, in order from an object side to an image side, a first lens unit, a second lens unit having negative refractive power, a third lens unit having positive refractive power, and a fourth lens unit. A distance between adjacent lens units changes during focusing. The third lens unit includes a plurality of lenses. The second lens unit and the third lens unit move during focusing. Predetermined inequalities are satisfied.

### BACKGROUND

### Technical Field

The present disclosure relates to an optical system suitable for imaging.

### Description of Related Art

In a case where a focus lens unit is driven in an optical system, an angle of view may vary or so-called breathing may occur. Japanese Patent Laid-Open No. 2016-118770 discloses an optical system that employs a so-called floating focus method for driving a plurality of focus lens units.

### SUMMARY

An optical system according to one aspect of the disclosure includes, in order from an object side to an image side, a first lens unit, a second lens unit having negative refractive power, a third lens unit having positive refractive power, and a fourth lens unit. A distance between adjacent lens units changes during focusing. The third lens unit includes a plurality of lenses. The second lens unit and the third lens unit move during focusing. The following inequalities are satisfied:

$$- 0.37 \leq f 3 / f 2 < 0$$

$$0 < LB 2 B 3 / TTL \leq 0.24$$

$$- 12. 0 \leq f 2 / f \leq - 3.$$

where f2 is a focal length of the second lens unit, f3 is a focal length of the third lens unit, LB2B3 is an air gap on an optical axis from a lens surface closest to an image plane of the second lens unit to a lens surface closest to an object of the third lens unit in an in-focus state on an object at infinity, TTL is a distance on the optical axis from a lens surface closest to the object of the optical system to the image plane in the in-focus state on the object at infinity, and fis a focal length of the optical system in the in-focus state on the object at infinity. An image pickup apparatus having the above optical system also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of an optical system according to Example 1.

FIG. 2A illustrates a longitudinal aberration of the optical system according to Example 1 in an in-focus state at infinity, and FIG. 2B illustrates a longitudinal aberration of the optical system according to Example 1 in an in-focus state at a close distance.

FIG. 3 is a sectional view of an optical system according to Example 2.

FIG. 4A illustrates a longitudinal aberration of the optical system according to Example 2 in an in-focus state at infinity, and FIG. 4B illustrates a longitudinal aberration of the optical system according to Example 2 in an in-focus state at a close distance.

FIG. 5 is a sectional view of an optical system according to Example 3.

FIG. 6A illustrates a longitudinal aberration of the optical system according to Example 3 in an in-focus state at infinity, and FIG. 6B illustrates a longitudinal aberration of the optical system according to Example 3 in an in-focus state at a close distance.

FIG. 7 is a sectional view of an optical system according to Example 4.

FIG. 8A illustrates a longitudinal aberration diagram of the optical system according to Example 4 in an in-focus state at infinity, and FIG. 8B illustrates a longitudinal aberration diagram of the optical system according to Example 4 in an in-focus state at a close distance.

FIG. 9 is a sectional view of an optical system according to Example 5.

FIG. 10A illustrates a longitudinal aberration diagram of the optical system according to Example 5 in an in-focus state at infinity, and FIG. 10B illustrates a longitudinal aberration diagram of the optical system according to Example 5 in an in-focus state at a close distance.

FIG. 11 is a schematic diagram of an image pickup apparatus including the optical system according to any one of Examples 1 to 5.

### DETAILED DESCRIPTION

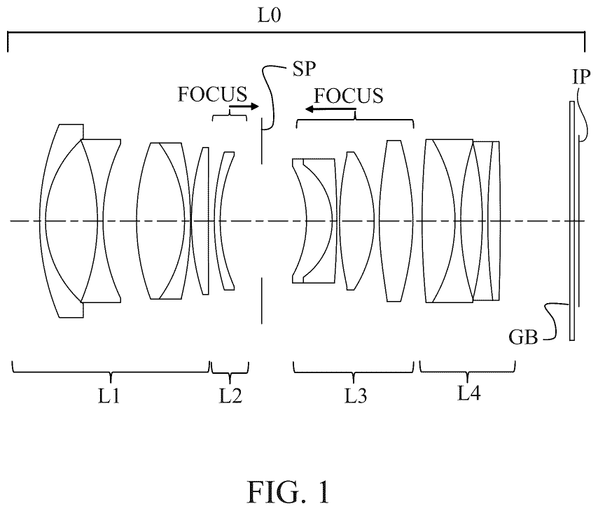

Examples of the present disclosure will be described below with reference to the drawings. FIGS. 1, 3, 5, 7, and 9 illustrate the configurations of the optical systems L0 according to Examples 1 to 5 in a state where the optical system is in focus on an object at infinity (referred to as “in an in-focus state at infinity” hereinafter). In each figure, a left side is an object side (front side), and a right side is an image side (rear side).

The optical system L0 according to each example includes a plurality of lens units. A lens unit is a group of one or more lenses that integrally move or do not move during zooming (magnification variation) or focusing. The lens unit may include an aperture stop (diaphragm).

In each figure, Li represents an i-th lens unit (where i is a natural number) counted from the object side in the optical system L0. Above the lens unit that moves during focusing, an arrow “FOCUS” indicates a moving direction of the lens unit during focusing from infinity to a close distance.

SP represents an aperture stop, and IP represents an image plane. Disposed on the image plane IP is an imaging surface of an image sensor (photoelectric conversion element) such as a CCD sensor or CMOS sensor, or a film plane (photosensitive surface) of a silver film. GB represents a glass block such as an optical filter disposed in front of the image plane IP. The glass block GB includes a parallel plate or a prism that does not have effective refractive power, and is not included in the optical system L0.

A description will now be given of the characteristics common to the optical systems L0 according to Examples 1 to 5. The optical system L0 according to each example includes, in order from the object side to the image side, a plurality of lens units that include a first lens unit L1, a second lens unit L2 having negative refractive power, a third lens unit L3 having positive refractive power, and a fourth lens unit L4.

During focusing, at least the second lens unit L2 and the third lens unit L3 move. Thus, the second lens unit L2 and the third lens unit L3 that move during focusing are given refractive powers with mutually different signs. This configuration can satisfactorily correct various aberrations such as curvature of field, lateral chromatic aberration, and coma that fluctuate during focusing, and suppress breathing during focusing (referred to as focus breathing hereinafter).

The third lens unit L3 includes a plurality of lenses. This configuration can prevent light rays incident on the third lens unit L3 from being significantly refracted, and suppress various aberrations such as spherical aberration and longitudinal chromatic aberration.

The fourth lens unit L4 is disposed on the image side of the third lens unit L3, and satisfactorily correct various aberrations such as curvature of field and lateral chromatic aberration.

The optical system L0 according to each example may satisfy the following inequalities (1) and (2). In inequalities (1) and (2), f2 is a focal length of the second lens unit L2, f3 is a focal length of the third lens unit L3, and LB2B3 is an air gap on the optical axis from a lens surface closest to the image plane of the second lens unit L2 to a lens surface closest to the object of the third lens unit L3 in an in-focus state at infinity. TTL is a distance on the optical axis (overall optical length) from a lens surface closest to the object of the lens closest to the object (front lens) of the optical system L0 to the image plane IP in an in-focus state at infinity.

$$- 0.37 \leq f 3 / f 2 < 0 \qquad ( 1 )$$

$$0 < LB 2 B 3 / TTL \leq 0.24 \qquad ( 2 )$$

Inequality (1) defines a proper relationship between the focal length of the second lens unit L2 and the focal length of the third lens unit L3. In a case where f3/f2 becomes lower than the lower limit of inequality (1), the refractive power of the second lens unit L2 becomes too strong and it becomes difficult to suppress focus breathing. In a case where f3/f2 becomes higher than the upper limit of inequality (1), the refractive powers of the second lens unit L2 and the third lens unit L3 have the same sign, and it becomes difficult to satisfactorily correct various aberrations such as curvature of field, lateral chromatic aberration, and coma, and to suppress focus breathing.

Inequality (2) defines a proper relationship between the air gap between the second lens unit L2 and the third lens unit L3 and the overall optical length of the optical system L0. In a case where LB2B3/TTL becomes higher than the upper limit of inequality (2), the air gap between the second lens unit L2 and the third lens unit L3 becomes too long relative to the overall optical length, and it becomes difficult to satisfactorily correct various aberrations such as curvature of field, lateral chromatic aberration, and coma, which fluctuate during focusing, and to suppress focus breathing. In a case where LB2B3/TTL becomes lower than the lower limit of inequality (2), the second lens unit L2 and the third lens unit L3 interfere with each other.

Inequalities (1) and (2) may be replaced with inequalities (1a) and (2a) below:

$$- 0.35 \leq f 3 / f 2 \leq - 0 \text{.06} \qquad ( 1 a )$$

$$0.02 \leq LB 2 B 3 / TTL \leq 0.23 \qquad ( 2 a )$$

Inequalities (1) and (2) may be replaced with inequalities (1b) and (2b) below:

$$- 0.33 \leq f 3 / f 2 \leq - 0 \text{.10} \qquad ( 1 b )$$

$$0.03 \leq LB 2 B 3 / TTL \leq 0.22 \qquad ( 2 b )$$

Satisfying the above configurations and inequalities can achieve an optical system that can suppress focus breathing and fluctuations in optical performance (various aberrations) during focusing.

The optical system L0 according to each example may satisfy at least one of the following inequalities (3) to (11):

$$- 12.0 \leq f 2 / f \leq - 3. \qquad ( 3 )$$

$$1.5 \leq \vert ( R 21 + R 22 ) / ( R 21 - R 22 ) \vert \leq 10. \qquad ( 4 )$$

$$- 10. 0 \leq ( R 31 + R 32 ) / ( R 31 - R 32 ) \leq - 2. \qquad ( 5 )$$

$$- 0.5 \; 0 \leq f 1 \; 23 / f 2 \leq - 0.01 \qquad ( 6 )$$

$$- 0.5 \; 0 \leq f 34 / f 2 \leq - 0.05 \qquad ( 7 )$$

$$0.2 \leq BF / f \leq 1.5 \qquad ( 8 )$$

$$0.4 \leq Do / TTL \leq 0.70 \qquad ( 9 )$$

$$1.5 \leq \vert ES 3 / ES 2 \vert \leq 20.00 \qquad ( 10 )$$

$$1.55 \leq Nd 4 L \leq 2.20 \qquad ( 11 )$$

In inequalities (3) to (11), f is a focal length of the optical system L0 in an in-focus state at infinity. R21 is a radius of curvature of a lens surface closest to the object of the second lens unit L2, R22 is a radius of curvature of a lens surface closest to the image plane of the second lens unit L2, R31 is a radius of curvature of a lens surface closest to the object of the third lens unit L3, and R32 is a radius of curvature of a lens surface closest to the image plane of the third lens unit L3. f123 is a combined focal length (including a focal length of an air lens between the lens units) from a lens closest to the object of the first lens unit L1 (foremost lens) to a lens closest to the image plane of the third lens unit L3, and f34 is a combined focal length from a lens closest to the object of the third lens unit L3 to a lens closest to the image plane of the fourth lens unit L4. BF is an air equivalent value (back focus) of a distance on the optical axis from a lens surface closest to the image plane of the optical system L0 to the image plane IP in an in-focus state at infinity, and Do is a distance on the optical axis from the aperture stop SP to the image plane IP in an in-focus state at infinity.

ES2 is the focus sensitivity of the second lens unit L2 and ES3 is the focus sensitivity of the third lens unit L3, where the second lens unit L2 and the third lens unit L3 are focus lens units that move during focusing. The focus sensitivity is a moving amount of the image plane IP per unit moving amount of the focus lens unit that moves during focusing. More specifically, where Bf is a lateral magnification of the focus lens unit and BR is a combined lateral magnification of all lenses disposed on the image side of the focus lens unit, the following equation holds:

$$E S = ( 1 - β {f}^{2} ) \times β {R}^{2}$$

Nd4L is a refractive index of the convex lens with the lowest refractive index for the d-line among convex lenses included in the fourth lens unit L4.

Inequality (3) defines a proper relationship between the focal length of the optical system L0 and the focal length of the second lens unit in an in-focus state at infinity. In a case where f2/f becomes lower than the lower limit of inequality (3), the refractive power of the second lens unit L2 becomes too weak, which is beneficial to suppressing focus breathing, but a moving amount of the second lens unit L2 during focusing increases and it becomes difficult to correct curvature of field. In a case where f2/f becomes higher than the upper limit of inequality (3), the refractive power of the second lens unit L2 becomes too strong, and it becomes difficult to suppress focus breathing.

Inequality (4) defines a proper shape for the second lens unit L2. In a case where the shape factor |(R21+R22)/(R21−R22)| becomes lower than the lower limit of inequality (4), the curvature of one concave surface in the second lens unit L2 becomes stronger than that of the other concave surface, and the second lens unit L2 has a shape that is far from concentric. As a result, it becomes difficult to suppress focus breathing. On the other hand, in a case where |(R21+R22)/(R21−R22)| becomes higher than the upper limit of inequality (4), a meniscus shape of the second lens unit L2 becomes too strong, it becomes difficult to correct various aberrations such as curvature of field and coma.

Inequality (5) defines a proper shape for the third lens unit L3. In a case where the shape factor (R31+R32)/(R31−R32) becomes lower than the lower limit of inequality (5), the meniscus shape of the third lens unit L3 becomes too strong, and it becomes difficult to correct various aberrations such as curvature of field and coma. In a case where (R31+R32)/(R31−R32) becomes higher than the upper limit of inequality (5), the meniscus shape of the third lens unit L3 becomes too weak, and it becomes difficult to suppress focus breathing.

Inequality (6) defines a proper relationship between the combined focal length of the first lens unit L1, the second lens unit L2, and the third lens unit L3 and the focal length of the second lens unit L2. In a case where f123/f2 becomes lower than the lower limit of inequality (6), the refractive power of the second lens unit L2 becomes too strong, and it becomes difficult to suppress focus breathing. In a case where f123/f2 becomes higher than the upper limit of inequality (6), the combined refractive power of the first to third lens units L1 to L3 becomes too strong, and it becomes difficult to correct various aberrations such as spherical aberration and longitudinal chromatic aberration.

Inequality (7) defines a proper relationship between the combined focal length of the third lens unit L3 and the fourth lens unit L4 and the focal length of the second lens unit L2. In a case where f34/f2 becomes lower than the lower limit of inequality (7), the refractive power of the second lens unit L2 becomes too strong, and it becomes difficult to suppress focus breathing. In a case where f34/f2 becomes higher than the upper limit of inequality (7), the combined refractive power of the third and fourth lens units L3 and L4 becomes too strong, and it becomes difficult to correct various aberrations such as curvature of field and lateral chromatic aberration.

Inequality (8) defines a proper relationship between the back focus of the optical system L0 and the focal length of the optical system L0 in an in-focus state at infinity. In a case where BF/f becomes lower than the lower limit of inequality (8), it is beneficial to correcting various aberrations such as curvature of field and lateral chromatic aberration and to reduce the size of the optical system L0, but an incident angle of a light beam incident on the image sensor disposed on the image plane IP increases and the light condensing efficiency of the image sensor lowers. In a case where BF/f becomes higher than the upper limit of inequality (8), the back focus becomes too long and it becomes difficult to correct various aberrations such as curvature of field and lateral chromatic aberration and to reduce the size of the optical system L0.

Inequality (9) defines a proper relationship between the distance from the aperture stop SP to the image plane IP in an in-focus state at infinity and the overall optical length of the optical system L0. In a case where Do/TTL becomes lower than the lower limit of inequality (9), the aperture stop SP is too close to the image sensor disposed on the image plane IP and an incident angle of a light beam incident on the image sensor increases and the light condensing efficiency of the image sensor lowers. In addition, the diameter of the front lens of the optical system L0 increases, and it becomes difficult to reduce the size of the optical system L0. In a case where Do/TTL becomes higher than the upper limit of inequality (9), the aperture stop SP moves too close to the object side, the diameter of the aperture stop SP increases, and it becomes difficult to reduce the size of the optical system L0.

Inequality (10) defines a proper relationship between the focus sensitivity of the second lens unit L2 and the focus sensitivity of the third lens unit L3. In a case where |ES3/ES2| becomes lower than the lower limit of inequality (10), the focus sensitivity of the third lens unit L3 becomes too small, a moving amount of the third lens unit L3 during focusing increases, and the size of the optical system L0 increases. On the other hand, in a case where |ES3/ES2| becomes higher than the upper limit of inequality (10), the focus sensitivity of the second lens unit L2 becomes too small, a moving amount of the second lens unit L2 during focusing increases, the size of the optical system L0 increases, and it becomes difficult to correct curvature of field.

Inequality (11) defines a proper refractive index of the convex lens with the lowest refractive index in the fourth lens unit L4. In a case where Nd4L becomes lower than the lower limit of inequality (11), a radius of curvature of the convex lens to obtain the required refractive power becomes too strong, and it becomes difficult to correct various aberrations such as curvature of field and lateral chromatic aberration. In a case where Nd4L becomes higher than the upper limit of inequality (11), the radius of curvature of the convex lens to obtain the required refractive power becomes too weak, and it becomes difficult to correct various aberrations such as curvature of field and lateral chromatic aberration.

Inequalities (3) to (11) may be replaced with inequalities (3a) to (11a) below:

$$- 11. \leq f 2 / f \leq - 3.4 \qquad ( 3 a )$$

$$2. \leq \vert ( R 21 + R 22 ) / ( R 21 - R 22 ) \vert \leq 8. \qquad ( 4 a )$$

$$- 9.8 \; 0 \leq ( R 31 + R 32 ) / ( R 31 - R 32 ) \leq - 2.50 \qquad ( 5 a )$$

$$- 0.3 \; 2 \leq f 1 \; 23 / f 2 \leq - 0.04 \qquad ( 6 a )$$

$$- 0.4 \; 0 \leq f 34 / f 2 \leq - 0.12 \qquad ( 7 a )$$

$$0.25 \leq BF / f \leq 1.3 \qquad ( 8 a )$$

$$0.5 \leq Do / TTL \leq 0.67 \qquad ( 9 a )$$

$$2. \leq \vert ES 3 / ES 2 \vert \leq 18.50 \qquad ( 10 a )$$

$$1.7 \leq Nd 4 L \leq 2.10 \qquad ( 11 a )$$

Inequalities (3) to (11) may be replaced with inequalities (3b) to (11b) below:

$$- 10.0 \leq f 2 / f \leq - 3.5 \qquad ( 3 b )$$

$$2.1 \leq \vert ( R 21 + R 22 ) / ( R 21 - R 22 ) \vert \leq 7. 00 \qquad ( 4 b )$$

$$- 9.6 \; 0 \leq ( R 31 + R 32 ) / ( R 31 - R 32 ) \leq - 2.80 \qquad ( 5 b )$$

$$- 0.2 \; 8 \leq f 1 \; 23 / f 2 \leq - 0.06 \qquad ( 6 b )$$

$$- 0.3 \; 8 \leq f 34 / f 2 \leq - 0.14 \qquad ( 7 b )$$

$$0.3 \leq BF / f \leq 1.2 \qquad ( 8 b )$$

$$0.55 \leq Do / TTL \leq 0.66 \qquad ( 9 b )$$

$$2.2 \leq \vert ES 3 / ES 2 \vert \leq 17.50 \qquad ( 10 b )$$

$$1.75 \leq Nd 4 L \leq 2.05 \qquad ( 11 b )$$

The optical system L0 according to each example may include one of the following configurations.

The third lens unit L3 may include a cemented lens closest to the object and made of a positive meniscus lens having a concave surface facing the object side and a negative lens. This configuration can correct various aberrations such as spherical aberration and longitudinal chromatic aberration, and suppress aberration fluctuations during focusing.

The second lens unit L2 may include a negative lens closest to the object. Thereby, a negative lens can be disposed near the first lens unit, which has a relatively high on-axis light beam, and various aberrations, such as spherical aberration and longitudinal chromatic aberration, can be satisfactorily corrected. The third lens unit L3 may include a plurality of convex lenses. Thereby, the refractive power of the third lens unit L3 can be strong, so that the curvature of the convex lens does not become too strong, and various aberrations, such as spherical aberration and longitudinal chromatic aberration, can be suppressed.

The fourth lens unit L4 may include a plurality of lenses. Thereby, the curvature of the lens in the fourth lens unit L4 can be prevented from being too strong, and various aberrations, such as curvature of field and lateral chromatic aberration, can be suppressed. Lenses with different refractive powers can satisfactorily correct various aberrations, such as curvature of field and lateral chromatic aberration.

The first lens unit L1 may include a plurality of concave lenses. Thereby, the curvature of the concave lens in the first lens unit L1 can be prevented from being too strong, and various aberrations, such as curvature of field and lateral chromatic aberration, can be satisfactorily corrected or suppressed.

A detailed description will now be given of the optical system L0 according to each example.

The optical system L0 according to Example 1 illustrated in FIG. 1 includes, in order from the object side to the image side, a first lens unit L1 having positive refractive power, a second lens unit L2 having negative refractive power, a third lens unit L3 having positive refractive power, and a fourth lens unit L4 having negative refractive power. An aperture stop SP is disposed between the second lens unit L2 and the third lens unit L3. During focusing from infinity to a close distance, the second lens unit L2 moves toward the image side, and the third lens unit L3 moves toward the object side.

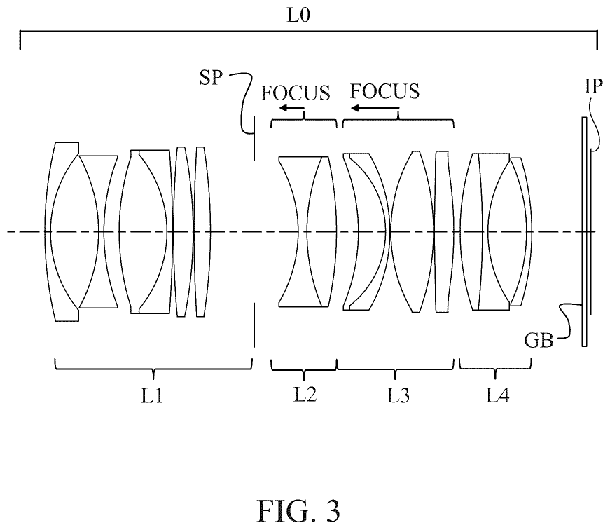

The optical system L0 according to Example 2 illustrated in FIG. 3 includes, in order from the object side to the image side, a first lens unit L1 having positive refractive power, a second lens unit L2 having negative refractive power, a third lens unit L3 having positive refractive power, and a fourth lens unit L4 having negative refractive power. An aperture stop SP is disposed between the first lens unit L1 and the second lens unit L2. During focusing from infinity to a close distance, both the second lens unit L2 and the third lens unit L3 move toward the object side.

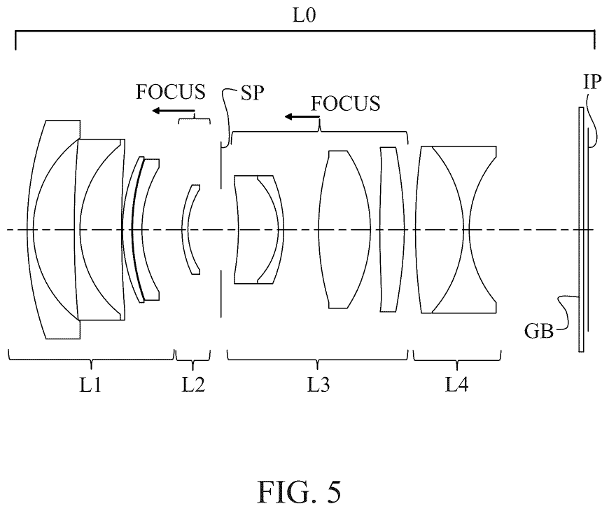

The optical system L0 according to Example 3 illustrated in FIG. 5 includes, in order from the object side to the image side, a first lens unit L1 having negative refractive power, a second lens unit L2 having negative refractive power, a third lens unit L3 having positive refractive power, and a fourth lens unit L4 having negative refractive power. An aperture stop SP is disposed between the second lens unit L2 and the third lens unit L3. During focusing from infinity to a close distance, both the second lens unit L2 and the third lens unit L3 move toward the object side.

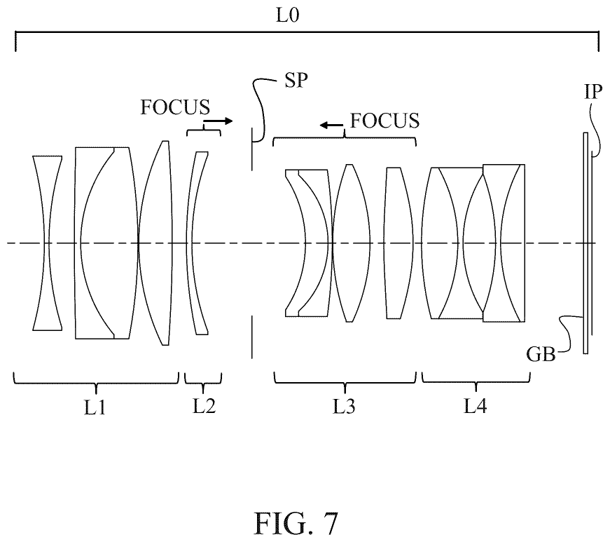

The optical system L0 according to Example 4 illustrated in FIG. 7 includes, in order from the object side to the image side, a first lens unit L1 having positive refractive power, a second lens unit L2 having negative refractive power, a third lens unit L3 having positive refractive power, and a fourth lens unit L4 having negative refractive power. An aperture stop SP is disposed between the second lens unit L2 and the third lens unit L3. During focusing from infinity to a close distance, the second lens unit L2 moves toward the image side, and the third lens unit L3 moves toward the object side.

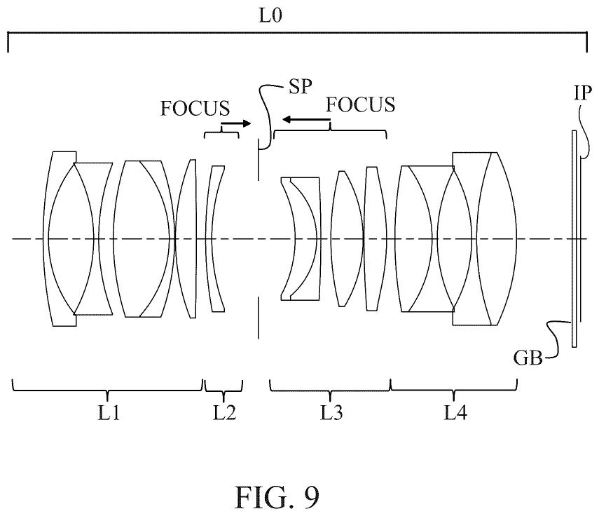

The optical system L0 according to Example 5 illustrated in FIG. 9 includes, in order from the object side to the image side, a first lens unit L1 having positive refractive power, a second lens unit L2 having negative refractive power, a third lens unit L3 having positive refractive power, and a fourth lens unit L4 having positive refractive power. An aperture stop SP is disposed between the second lens unit L2 and the third lens unit L3. During focusing from infinity to a close distance, the second lens unit L2 moves toward the image side, and the third lens unit L3 moves toward the object side.

Numerical examples 1 to 5 corresponding to Examples 1 to 5, respectively, will be illustrated below. In surface data in each numerical example, a surface number m indicates the order of a surface (lens surface or aperture surface) counted from the object side. r (mm) represents a radius of curvature of an m-th surface, d (mm) represents a distance on the optical axis between m-th and (m+1)-th surfaces. nd represents a refractive index for the d-line of an optical material between m-th and (m+1)-th surfaces, and vd represents an Abbe number based on the d-line of the optical material between m-th and (m+1)-th surfaces. The Abbe number vd based on the d-line is expressed as follows:

$$vd = ( Nd - 1 ) / ( NF - NC )$$

where Nd, NF, and NC are refractive indices for the d-line (with a wavelength of 587.6 nm), F-line (4 with a wavelength of 86.1 nm), and C-line (with a wavelength of 656.3 nm) in the Fraunhofer line.

In each numerical example, d, focal length (mm), F-number, and half angle of view (*) are all values in a case where the optical system according to each numerical example is in an in-focus state at infinity. Back focus (BF) is an air equivalent length that represents a distance on the optical axis from a lens surface closest to the image plane (final surface) of the optical system to the paraxial image plane. The overall lens length is a distance on the optical axis from the lens surface closest to the object (foremost surface) of the optical system to the final surface plus the back focus, and corresponds to the overall optical length. In each numerical example, an object distance (mm) in an in-focus state on an object at a finite distance indicates a distance on the optical axis from the image plane IP to the object.

An asterisk “*” next to a surface number means that a surface has an aspheric shape. The aspheric shape is expressed by the following equation:

$$X = \frac{( 1 / R ) {H}^{2}}{1 + \sqrt{1 - ( 1 + K ) {( H / R )}^{2}}} + A 4 \times {\vert H \vert}^{4} + A 6 \times {\vert H \vert}^{6} + A 8 \times {\vert H \vert}^{8} + A 10 \times {\vert H \vert}^{10} + A 12 \times {\vert H \vert}^{12}$$

where X is a displacement amount from a surface vertex in the optical axis direction, H is a height from the optical axis in a direction perpendicular to the optical axis, R is a paraxial radius of curvature, K is a conic constant, and A4, A6, A8, A10, and A12 are aspheric coefficients of each order. The “e±Z” in each aspheric coefficient means “×10^{±Z}.”

Tables 1 and 2 summarize values of inequalities (1) to (11) in numerical examples 1 to 5. The optical systems L0 according to numerical examples 1 to 5 satisfy all inequalities (1) to (11).

NUMERICAL EXAMPLE 1
UNIT: mm
SURFACE DATA

| Surface No. | r | d | nd | νd |
|---|---|---|---|---|
| 1 | 53.181 | 1.30 | 1.69349 | 50.8 |
| 2 | 23.707 | 11.39 | | |
| 3 | −44.340 | 1.21 | 1.49700 | 81.5 |
| 4 | 38.487 | 7.34 | | |
| 5 | 48.142 | 10.53 | 1.76385 | 48.5 |
| 6 | −28.586 | 1.30 | 1.85478 | 24.8 |
| 7 | −70.693 | 0.19 | | |
| 8 | 52.079 | 3.71 | 2.00069 | 25.5 |
| 9 | 7495.352 | (Variable) | | |
| 10 | 52.308 | 1.29 | 1.77047 | 29.7 |
| 11 | 34.606 | (Variable) | | |
| 12 (SP) | ∞ | (Variable) | | |
| 13 | −24.759 | 5.63 | 1.49700 | 81.5 |
| 14 | −15.000 | 1.00 | 1.77047 | 29.7 |
| 15 | −175.025 | 0.59 | | |
| 16 | 63.764 | 7.59 | 1.49700 | 81.5 |
| 17 | −27.632 | 1.10 | | |
| 18* | 67.630 | 7.39 | 1.80400 | 46.5 |
| 19* | −47.978 | (Variable) | | |
| 20 | 181.048 | 7.22 | 1.95375 | 32.3 |
| 21 | −34.114 | 1.25 | 1.77047 | 29.7 |
| 22 | 54.736 | 4.74 | | |
| 23 | −71.318 | 1.19 | 1.65412 | 39.7 |
| 24 | 138.028 | 2.75 | 1.92286 | 20.9 |
| 25 | −500.035 | 15.20 | | |
| 26 | ∞ | 1.00 | 1.51633 | 64.1 |
| 27 | ∞ | 1.00 | | |
| Image Plane | ∞ | | | |

ASPHERIC DATA
18th Surface
K = 0.00000e+00 A 4 = −5.65304e−06 A 6 = 5.53536e−09
A 8 = −3.00386e−11 A10 = 9.16452e−14 A12 = −2.01097e−16
19th Surface
K = 0.00000e+00 A 4 = 6.31684e−06 A 6 = 4.51680e−09
A 8 = −2.25389e−11 A10 = 9.25935e−14 A12 = −1.87097e−16

VARIOUS DATA

| | |
|---|---|
| ZOOM RATIO | 1.00 |
| Focal Length | 24.72 |
| Fno | 1.44 |
| Half Angle of View (°) | 37.03 |
| Image Height | 18.64 |
| Overall Lens Length | 117.81 |
| BF | 17.20 |

| Object Distance | Infinity | −240 |
|---|---|---|
| d9 | 1.30 | 4.19 |
| d11 | 9.12 | 6.23 |
| d12 | 9.81 | 6.91 |
| d19 | 2.00 | 4.90 |

LENS UNIT DATA

| Lens Unit | Starting Surface | Focal Length |
|---|---|---|
| 1 | 1 | 38.12 |
| 2 | 10 | −137.06 |
| 3 | 13 | 31.69 |
| 4 | 20 | −118.82 |

NUMERICAL EXAMPLE 2
UNIT: mm
SURFACE DATA

| Surface No. | r | d | nd | νd |
|---|---|---|---|---|
| 1 | 84.764 | 1.30 | 1.60311 | 60.6 |
| 2 | 27.757 | 11.00 | | |
| 3 | −35.589 | 1.21 | 1.49700 | 81.5 |
| 4 | 46.961 | 3.50 | | |
| 5 | 54.948 | 10.94 | 1.76385 | 48.5 |
| 6 | −27.209 | 1.30 | 1.85478 | 24.8 |
| 7 | −234.377 | 0.20 | | |
| 8 | 209.866 | 4.51 | 2.00069 | 25.5 |
| 9 | −96.169 | 0.20 | | |
| 10 | 295.467 | 3.76 | 1.76385 | 48.5 |
| 11 | −123.342 | 10.04 | | |
| 12 (SP) | ∞ | (Variable) | | |
| 13 | −31.294 | 2.00 | 1.67300 | 38.3 |
| 14 | 43.809 | 6.79 | 1.89190 | 37.1 |
| 15 | −76.299 | (Variable) | | |
| 16 | −42.414 | 6.23 | 1.43875 | 94.7 |
| 17 | −21.158 | 1.00 | 1.77047 | 29.7 |
| 18 | −35.162 | 0.20 | | |
| 19 | 35.666 | 9.77 | 1.43875 | 94.7 |
| 20 | −52.978 | 0.20 | | |
| 21* | 195.038 | 4.44 | 1.80400 | 46.5 |
| 22* | −84.967 | (Variable) | | |
| 23 | 56.435 | 5.11 | 1.91082 | 35.3 |
| 24 | −165.698 | 1.25 | 1.77047 | 29.7 |
| 25 | 28.523 | 8.85 | | |
| 26 | −38.320 | 1.20 | 1.65160 | 58.5 |
| 27 | −57.201 | 11.54 | | |
| 28 | ∞ | 1.00 | 1.51633 | 64.1 |
| 29 | ∞ | 1.00 | | |
| Image Plane | ∞ | | | |

ASPHERIC DATA
21st Surface
K = 0.00000e+00 A 4 = −9.08036e−06 A 6 = 2.48605e−09
A 8 = 4.53982e−12 A10 = 1.97345e−13 A12 = −2.97642e−16
22nd Surface
K = 0.00000e+00 A 4 = −5.91166e−07 A 6 = 5.59824e−09
A 8 = 4.96338e−12 A10 = 1.93055e−13 A12 = −2.48779e−16

VARIOUS DATA

| | |
|---|---|
| ZOOM RATIO | 1.00 |
| Focal Length | 27.62 |
| Fno | 1.24 |
| Half Angle of View (°) | 34.33 |
| Image Height | 18.86 |
| Overall Lens Length | 124.66 |
| BF | 13.54 |

| Object Distance | Infinity | −300 |
|---|---|---|
| d12 | 10.03 | 5.48 |
| d15 | 5.00 | 6.81 |
| d22 | 1.45 | 4.18 |

LENS UNIT DATA

| Lens Unit | Starting Surface | Focal Length |
|---|---|---|
| 1 | 1 | 78.63 |
| 2 | 13 | −270.00 |
| 3 | 16 | 32.51 |
| 4 | 23 | −70.97 |

NUMERICAL EXAMPLE 3
UNIT: mm
SURFACE DATA

| Surface No. | r | d | nd | νd |
|---|---|---|---|---|
| 1 | 68.591 | 1.30 | 1.85150 | 40.8 |
| 2 | 23.921 | 8.81 | | |
| 3 | 216.106 | 1.22 | 1.49700 | 81.5 |
| 4 | 23.000 | 8.95 | 1.88300 | 40.8 |
| 5 | 224.462 | 0.19 | | |
| 6 | 34.721 | 1.99 | 2.00100 | 29.1 |
| 7 | 44.344 | 0.19 | | |
| 8 | 44.356 | 1.99 | 1.49700 | 81.5 |
| 9 | 25.687 | (Variable) | | |
| 10 | 21.924 | 1.29 | 1.49700 | 81.5 |
| 11 | 15.850 | (Variable) | | |
| 12 (SP) | ∞ | (Variable) | | |
| 13 | −55.083 | 8.57 | 1.49700 | 81.5 |
| 14 | −15.165 | 1.16 | 1.85478 | 24.8 |
| 15 | −28.994 | 7.49 | | |
| 16 | 55.800 | 11.13 | 1.49700 | 81.5 |
| 17 | −30.538 | 2.01 | | |
| 18* | 181.350 | 5.25 | 1.80400 | 46.5 |
| 19* | −68.044 | (Variable) | | |
| 20 | 123.519 | 10.33 | 1.80400 | 46.5 |
| 21 | −26.172 | 1.20 | 1.61340 | 44.3 |
| 22 | 23.632 | 23.58 | | |
| 23 | ∞ | 1.00 | 1.51633 | 64.1 |
| 24 | ∞ | 1.00 | | |
| Image Plane | ∞ | | | |

ASPHERIC DATA
18th Surface
K = 0.00000e+00 A 4 = −4.84049e−06 A 6 = 6.66659e−09
A 8 = −9.57538e−11 A10 = 3.49919e−13 A12 = −7.42226e−16
19th Surface
K = 0.00000e+00 A 4 = 6.01015e−06 A 6 = 5.60753e−09
A 8 = −4.96845e−11 A10 = 1.97676e−13 A12 = −4.44356e−16

VARIOUS DATA

| | |
|---|---|
| ZOOM RATIO | 1.00 |
| Focal Length | 24.34 |
| Fno | 1.80 |
| Half Angle of View (°) | 37.81 |
| Image Height | 18.89 |
| Overall Lens Length | 120.16 |
| BF | 25.58 |

| Object Distance | Infinity | −240 |
|---|---|---|
| d9 | 8.59 | 1.99 |
| d11 | 7.10 | 13.71 |
| d12 | 3.74 | 1.44 |
| d19 | 2.41 | 4.71 |

LENS UNIT DATA

| Lens Unit | Starting Surface | Focal Length |
|---|---|---|
| 1 | 1 | −181.58 |
| 2 | 10 | −123.85 |
| 3 | 13 | 25.42 |
| 4 | 20 | −89.22 |

NUMERICAL EXAMPLE 4
UNIT: mm
SURFACE DATA

| Surface No. | r | d | nd | νd |
|---|---|---|---|---|
| 1 | −77.699 | 1.10 | 1.72047 | 34.7 |
| 2 | 65.828 | 6.03 | | |
| 3 | 717.957 | 1.50 | 1.77047 | 29.7 |
| 4 | 33.249 | 13.60 | 1.76385 | 48.5 |
| 5 | −117.421 | 0.21 | | |
| 6 | 54.033 | 7.93 | 2.00069 | 25.5 |
| 7 | −320.908 | (Variable) | | |
| 8 | 99.154 | 1.30 | 1.65412 | 39.7 |
| 9 | 58.728 | (Variable) | | |
| 10 (SP) | ∞ | (Variable) | | |
| 11 | −28.460 | 5.37 | 1.49700 | 81.5 |
| 12 | −21.800 | 1.00 | 1.85478 | 24.8 |
| 13 | −125.854 | 0.10 | | |
| 14 | 53.605 | 8.84 | 1.49700 | 81.5 |
| 15 | −43.060 | 3.29 | | |
| 16* | 131.304 | 6.95 | 1.80400 | 46.5 |
| 17* | −47.702 | (Variable) | | |
| 18 | 68.927 | 8.62 | 1.83481 | 42.7 |
| 19 | −36.506 | 1.25 | 1.74951 | 35.3 |
| 20 | 30.422 | 7.72 | | |
| 21 | −46.017 | 1.20 | 1.61340 | 44.3 |
| 22 | 38.811 | 5.73 | 1.92286 | 20.9 |
| 23 | −5026.441 | 13.98 | | |
| 24 | ∞ | 1.00 | 1.51633 | 64.1 |
| 25 | ∞ | 1.00 | | |
| Image Plane | ∞ | | | |

ASPHERIC DATA
16th Surface
K = 0.00000e+00 A 4 = −5.58992e−06 A 6 = −5.81792e−10
A 8 = 2.77849e−12 A10 = −3.56043e−15 A12 = 8.74910e−17
17th Surface
K = 0.00000e+00 A 4 = 2.98915e−06 A 6 = −2.19539e−09
A 8 = 1.86567e−11 A10 = −5.02691e−14 A12 = 1.50963e−16

VARIOUS DATA

| | |
|---|---|
| ZOOM RATIO | 1.00 |
| Focal Length | 48.61 |
| Fno | 1.44 |
| Half Angle of View (°) | 23.99 |
| Image Height | 21.64 |
| Overall Lens Length | 129.72 |
| BF | 15.98 |

| Object Distance | Infinity | −400 |
|---|---|---|
| d7 | 3.37 | 11.15 |
| d9 | 14.26 | 6.48 |
| d10 | 12.72 | 8.46 |
| d17 | 2.01 | 6.27 |

LENS UNIT DATA

| Lens Unit | Starting Surface | Focal Length |
|---|---|---|
| 1 | 1 | 58.89 |
| 2 | 8 | −223.05 |
| 3 | 11 | 42.47 |
| 4 | 18 | −73.00 |

NUMERICAL EXAMPLE 5
UNIT: mm
SURFACE DATA

| Surface No. | r | d | nd | vd |
|---|---|---|---|---|
| 1 | 92.543 | 1.30 | 1.48749 | 70.2 |
| 2 | 28.922 | 10.96 | | |
| 3 | −36.379 | 1.22 | 1.51742 | 52.4 |
| 4 | 50.223 | 3.55 | | |
| 5 | 61.042 | 13.56 | 1.76385 | 48.5 |
| 6 | −27.661 | 1.30 | 1.85478 | 24.8 |
| 7 | −54.624 | 0.19 | | |
| 8 | 52.026 | 5.07 | 2.00069 | 25.5 |
| 9 | −946.627 | (Variable) | | |
| 10 | 95.124 | 1.50 | 1.77047 | 29.7 |
| 11 | 47.562 | (Variable) | | |
| 12 (SP) | ∞ | (Variable) | | |
| 13 | −28.511 | 5.23 | 1.49700 | 81.5 |
| 14 | −17.984 | 1.00 | 1.77047 | 29.7 |
| 15 | −246.706 | 2.42 | | |
| 16 | 66.332 | 7.83 | 1.49700 | 81.5 |
| 17 | −31.411 | 0.19 | | |
| 18* | 171.715 | 5.50 | 1.85400 | 40.4 |
| 19* | −50.789 | (Variable) | | |
| 20 | 93.764 | 9.02 | 1.78800 | 47.4 |
| 21 | −29.378 | 1.25 | 1.77047 | 29.7 |
| 22 | 36.043 | 8.36 | | |
| 23 | −33.721 | 1.19 | 1.61340 | 44.3 |
| 24 | 60.722 | 9.69 | 2.00069 | 25.5 |
| 25 | −47.682 | 13.50 | | |
| 26 | ∞ | 1.00 | 1.51633 | 64.1 |
| 27 | ∞ | 1.00 | | |
| Image Plane | ∞ | | | |

ASPHERIC DATA
18th Surface
K = 0.00000e+00 A 4 = −4.97076e−06 A 6 = 3.30627e−09
A 8 = 2.12404e−11 A10 = −4.09579e−15 A12 = 8.64092e−17
19th Surface
K = 0.00000e+00 A 4 = 3.12399e−06 A 6 = 4.44051e−09
A 8 = 1.96810e−11 A10 = 3.19130e−15 A12 = 1.15698e−16

VARIOUS DATA

| | |
|---|---|
| ZOOM RATIO | 1.00 |
| Focal Length | 34.00 |
| Fno | 1.44 |
| Half Angle of View (°) | 30.34 |
| Image Height | 19.90 |
| Overall Lens Length | 129.94 |
| BF | 15.50 |

| Object Distance | Infinity | −280 |
|---|---|---|
| d9 | 2.25 | 6.43 |
| d11 | 11.29 | 7.11 |
| d12 | 8.92 | 4.67 |
| d19 | 2.00 | 6.25 |

LENS UNIT DATA

| Lens Unit | Starting Surface | Focal Length |
|---|---|---|
| 1 | 1 | 39.71 |
| 2 | 10 | −125.18 |
| 3 | 13 | 38.73 |
| 4 | 20 | 800.02 |

TABLE 1

Numerical Example

| | 1 | 2 | 3 | 4 | 5 |
|---|---|---|---|---|---|
| f3 | 31.69 | 32.51 | 25.42 | 42.47 | 38.73 |
| f2 | −137.06 | −270.00 | −123.85 | −223.05 | −125.18 |
| LB2B3 | 18.93 | 5.00 | 10.85 | 26.98 | 20.22 |
| TTL | 118.15 | 125.00 | 120.50 | 130.06 | 130.28 |
| f | 24.72 | 27.62 | 24.34 | 48.61 | 34.00 |
| R21 | 52.31 | −31.29 | 21.92 | 99.15 | 95.12 |
| R22 | 34.61 | −76.30 | 15.85 | 58.73 | 47.56 |
| R31 | −24.76 | −42.41 | −55.08 | −28.46 | −28.51 |
| R32 | −47.98 | −84.97 | −68.04 | −47.70 | −50.79 |
| f123 | 21.43 | 22.54 | 19.70 | 38.22 | 29.21 |
| f34 | 40.61 | 43.82 | 28.39 | 81.11 | 44.02 |
| BF | 17.20 | 13.54 | 25.58 | 15.98 | 15.50 |
| Do | 69.46 | 77.05 | 78.87 | 80.77 | 78.10 |
| ES3 | 1.19 | 1.46 | 1.39 | 1.29 | 1.11 |
| ES2 | −0.28 | −0.08 | 0.12 | −0.35 | −0.49 |
| Nd4L | 1.92 | 1.91 | 1.80 | 1.83 | 1.79 |

TABLE 2

| | Numerical Example | | | | |
|---|---|---|---|---|---|
| | 1 | 2 | 3 | 4 | 5 |
| (1)f3/f2 | −0.23 | −0.12 | −0.21 | −0.19 | −0.31 |
| (2)LB2B3/TTL | 0.16 | 0.04 | 0.09 | 0.21 | 0.16 |
| (3)f2/f | −5.55 | −9.78 | −5.09 | −4.59 | −3.68 |
| (4)\|(R21 + R22)/(R21 − R22)\| | 4.91 | 2.39 | 6.22 | 3.91 | 3.00 |
| (5)(R31 + R32)/(R31 − R32) | −3.13 | −2.99 | −9.50 | −3.96 | −3.56 |
| (6)f123/f2 | −0.16 | −0.08 | −0.16 | −0.17 | −0.23 |
| (7)f34/f2 | −0.30 | −0.16 | −0.23 | −0.36 | −0.35 |
| (8)BF/f | 0.70 | 0.49 | 1.05 | 0.33 | 0.46 |
| (9)Do/TTL | 0.59 | 0.62 | 0.65 | 0.62 | 0.60 |
| (10)\|ES3/ES2\| | 4.25 | 17.41 | 11.37 | 3.66 | 2.28 |
| (11)Nd4L | 1.92 | 1.91 | 1.80 | 1.83 | 1.79 |

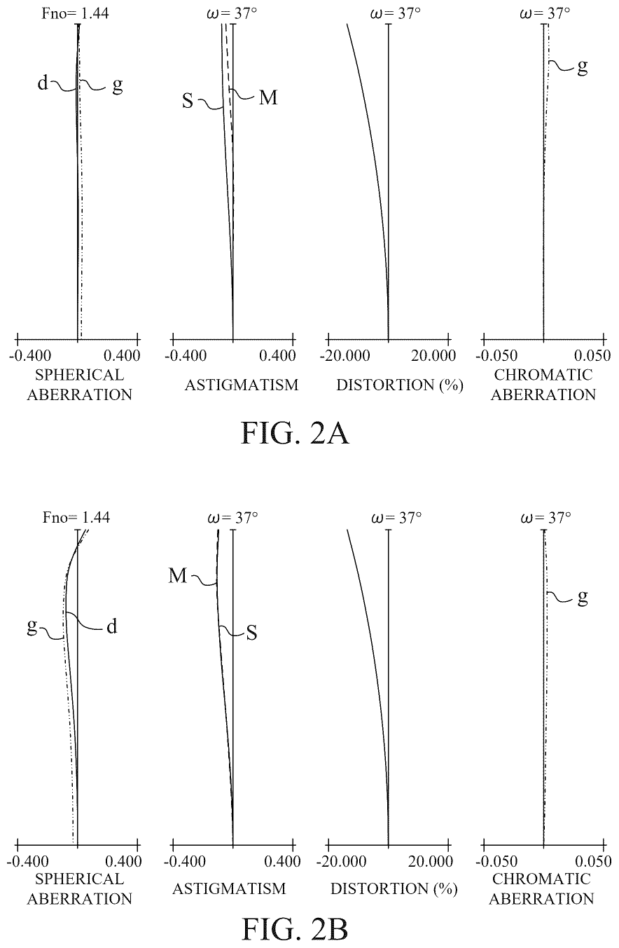

FIGS. 2A, 4A, 6A, 8A, and 10A respectively illustrate longitudinal aberrations (spherical aberration, astigmatism, distortion, and chromatic aberration) of the optical systems L0 according to numerical examples 1 to 5 in an in-focus state at infinity.

FIGS. 2B, 4B, 6B, 8B, and 10B respectively illustrate longitudinal aberrations of the optical systems L0 according to numerical examples 1 to 5 in an in-focus state at an object at a close distance (in an in-focus at a close distance).

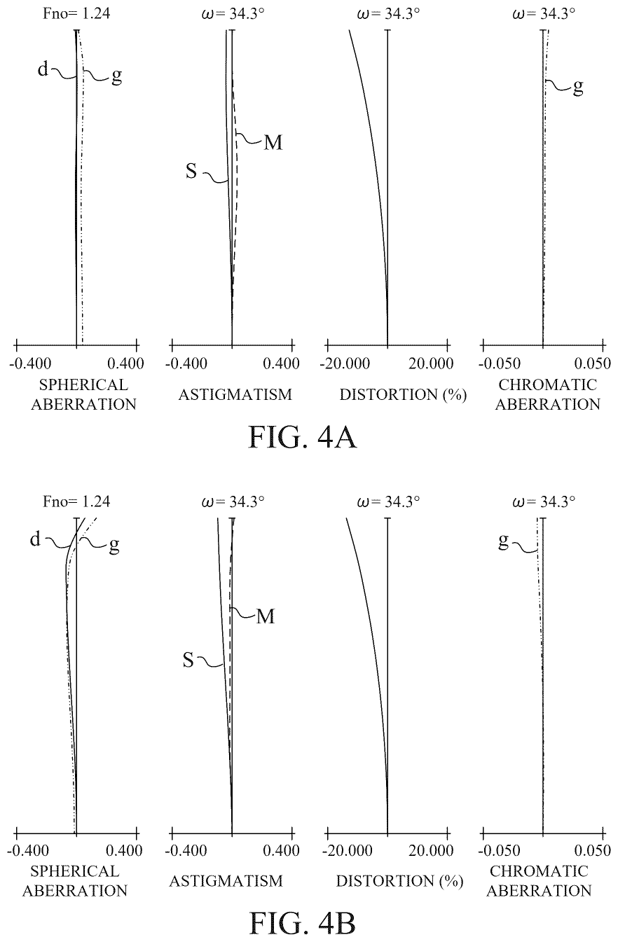

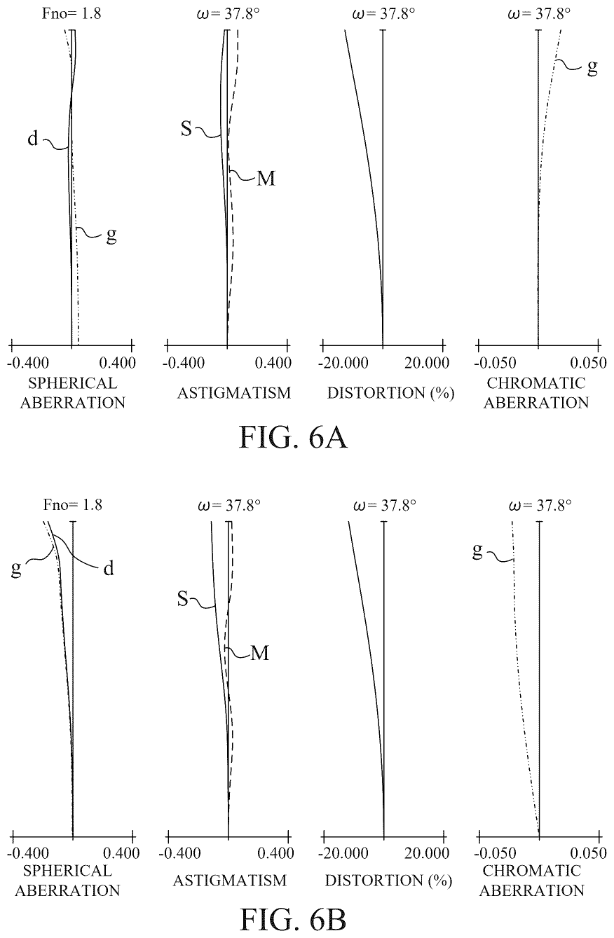

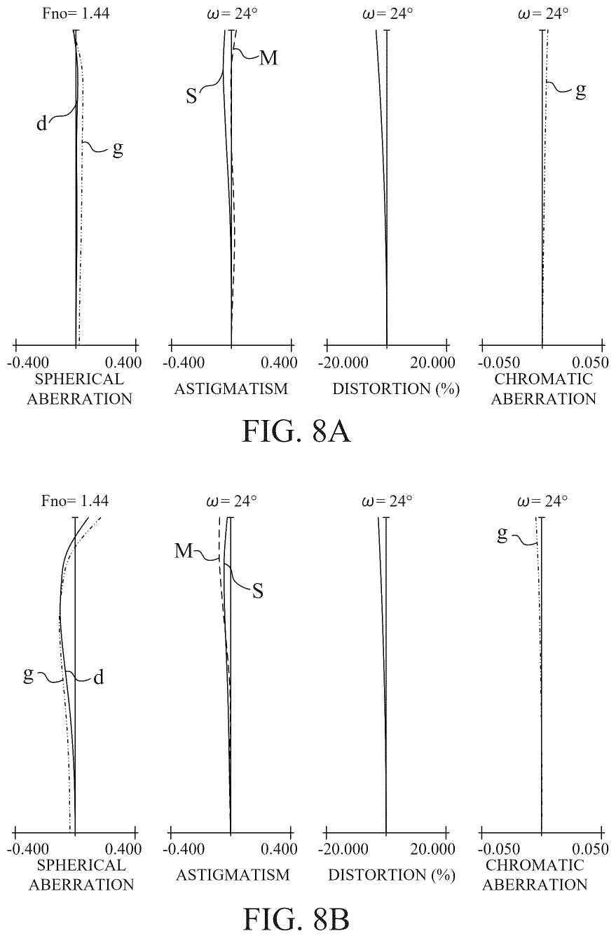

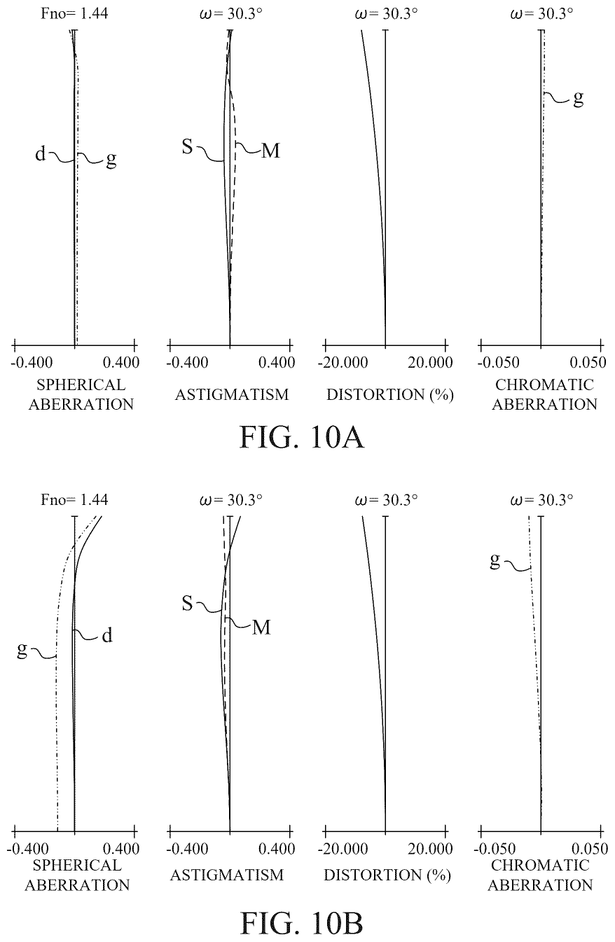

An object disposed at a close distance is an object 240 mm away on the optical axis from the image plane IP in FIG. 2B, an object 300 mm away on the optical axis from the image plane IP in FIG. 4B, an object 240 mm away on the optical axis from the image plane IP in FIG. 6B, an object 400 mm away on the optical axis from the image plane IP in FIG. 8B, and an object 280 mm away on the optical axis from the image plane IP in FIG. 10B.

In the spherical aberration diagram, a solid line indicates a spherical aberration amount for the d-line, and an alternate long and two short dashes line indicates a spherical aberration amount for the g-line (with a wavelength of 435.8 nm). In the astigmatism diagram, a dashed line M indicates an astigmatism amount on a meridional image plane, and a solid line S indicates an astigmatism amount on a sagittal image plane. The distortion aberration diagram illustrates a distortion amount for the d-line. The chromatic aberration diagram illustrates a lateral chromatic aberration amount for the g-line. ω indicates a half angle of view (°), and Fno indicates an F-number.

### Image Pickup Apparatus

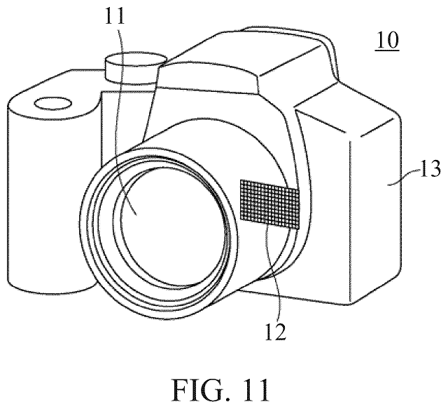

FIG. 11 illustrates a digital still camera (image pickup apparatus) 10 that uses the optical system L0 according to any one of Examples 1 to 5 as the imaging optical system. In FIG. 11, reference numeral 13 denotes a camera body, and reference numeral 11 denotes the imaging optical system as the optical system L0 according to any one of Examples 1 to 5. Reference numeral 12 denotes an image sensor (photoelectric conversion element) such as a CCD sensor or CMOS sensor that is built into a camera body 13 and photoelectrically converts an optical image formed by the imaging optical system 11 (i.e., images an object).

The camera body 13 may be a single-lens reflex camera having a quick-turn mirror, or a mirrorless camera having no quick-turn mirror. The camera body 13 may also be a lens interchangeable type camera to which the imaging optical system 11 can be detachably attached, or a lens integrated type camera is integrated with the imaging optical system 11.

Thus, using the optical system L0 according to each example as the imaging optical system 11 in an image pickup apparatus such as a digital still camera can suppress focus breathing and degradation of image quality due to focusing.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide an optical system that can suppress breathing and fluctuations in optical performance during focusing.

This application claims priority to Japanese Patent Application No. 2024-003272, which was filed on Jan. 12, 2024, and which is hereby incorporated by reference herein in its entirety.

What is claimed is:

1. An optical system comprising, in order from an object side to an image side:
a first lens unit;
a second lens unit having negative refractive power;
a third lens unit having positive refractive power; and
a fourth lens unit,
wherein a distance between adjacent lens units changes during focusing,
wherein the third lens unit includes a plurality of lenses,
wherein the second lens unit and the third lens unit move during focusing, and
wherein the following inequalities are satisfied:
$$- 0.37 \leq f 3 / f 2 < 0$$
$$0 < LB 2 B 3 / TTL \leq 0.24$$
$$- 12. 0 \leq f 2 / f \leq - 3.$$
where f2 is a focal length of the second lens unit, f3 is a focal length of the third lens unit, LB2B3 is an air gap on an optical axis from a lens surface closest to an image plane of the second lens unit to a lens surface closest to an object of the third lens unit in an in-focus state on an object at infinity, TTL is a distance on the optical axis from a lens surface closest to the object of the optical system to the image plane in the in-focus state on the object at infinity, and f is a focal length of the optical system in the in-focus state on the object at infinity.

2. The optical system according to claim 1, wherein the following inequality is satisfied:
$$1.5 \leq \vert ( R 21 + R 22 ) / ( R 21 - R 22 ) \vert \leq 10.00$$
where R21 is a radius of curvature of a lens surface closest to the object of the second lens unit, and R22 is a radius of curvature of the lens surface closest to the image plane of the second lens unit.

3. The optical system according to claim 1, wherein the following inequality is satisfied:
$$- 10.0 \leq ( R 31 + R 32 ) / ( R 31 - R 32 ) \leq - 2.0$$
where R31 is a radius of curvature of the lens surface closest to the object of the third lens unit, and R32 is a radius of curvature of a lens surface closest to the image plane of the third lens unit.

4. The optical system according to claim 1, wherein the following inequality is satisfied:
$$- 0.50 \leq f 123 / f 2 \leq - 0.01$$
where f123 is a combined focal length from a lens closest to the object in the first lens unit to a lens closest to the image plane in the third lens unit.

5. The optical system according to claim 1, wherein the following inequality is satisfied:
$$- 0.50 \leq f 34 / f 2 \leq - 0.05$$
where f34 is a combined focal length from a lens closest to the object in the third lens unit to a lens closest to the image plane in the fourth lens unit.

6. The optical system according to claim 1, wherein the following inequality is satisfied:
$$0. 20 \leq BF / f \leq 1.5$$
where BF is an air equivalent value of a distance on the optical axis from a lens surface closest to the image plane in the optical system to the image plane in the in-focus state on the object at infinity, and f is a focal length of the optical system in the in-focus state on the object at infinity.

7. The optical system according to claim 1, wherein the following inequality is satisfied:
$$0. 40 \leq Do / TTL \leq 0.70$$
where Do is a distance on the optical axis from an aperture stop to the image plane in the in-focus state on the object at infinity.

8. The optical system according to claim 1, wherein a focus sensitivity is defined as a moving amount of the image plane relative to a unit moving amount, and the following inequality is satisfied:
$$1. 50 \leq \vert ES 3 / ES 2 \vert \leq 20.00$$
where ES2 is a focus sensitivity of the second lens unit, and ES3 is a focus sensitivity of the third lens unit.

9. The optical system according to claim 1, wherein the fourth lens unit includes at least one convex lens, and
wherein the following inequality is satisfied:
$$1. 55 \leq Nd 4 L \leq 2.20$$
where Nd4L is a refractive index of a convex lens having a lowest refractive index for d-line among the at least one convex lens.

10. The optical system according to claim 1, wherein the third lens unit includes a cemented lens closest to the object and made of a positive meniscus lens having a concave surface facing the object side and a negative lens.

11. The optical system according to claim 1, wherein the second lens unit includes a negative lens closest to the object.

12. The optical system according to claim 1, wherein the third lens unit includes a plurality of convex lenses.

13. The optical system according to claim 1, wherein the fourth lens unit includes a plurality of lenses.

14. The optical system according to claim 1, wherein the first lens unit includes a plurality of concave lenses.

15. The optical system according to claim 1, wherein the first lens unit has positive refractive power, and
wherein the fourth lens unit has negative refractive power.

16. The optical system according to claim 1, wherein the first lens unit has positive refractive power, and
wherein the fourth lens unit has positive refractive power.

17. The optical system according to claim 1, wherein the first lens unit has negative refractive power, and
wherein the fourth lens unit has negative refractive power.

18. An image pickup apparatus comprising:
an optical system; and
an image sensor configured to image an object through the optical system,
wherein the optical system includes, in order from an object side to an image side:
a first lens unit;
a second lens unit having negative refractive power;
a third lens unit having positive refractive power; and
a fourth lens unit,
wherein a distance between adjacent lens units changes during focusing,
wherein the third lens unit includes a plurality of lenses,
wherein the second lens unit and the third lens unit move during focusing, and
wherein the following inequalities are satisfied:
$$- 0.37 \leq f 3 / f 2 < 0$$
$$0 < LB 2 B 3 / TTL \leq 0.24$$
$$- 12. 0 \leq f 2 / f \leq - 3.$$
where f2 is a focal length of the second lens unit, f3 is a focal length of the third lens unit, LB2B3 is an air gap on an optical axis from a lens surface closest to an image plane of the second lens unit to a lens surface closest to an object of the third lens unit in an in-focus state on an object at infinity, TTL is a distance on the optical axis from a lens surface closest to the object of the optical system to the image plane in the in-focus state on the object at infinity, and f is a focal length of the optical system in the in-focus state on the object at infinity.
